(19) United States
(12) Patent Application Publication
(10) Pub. No.: US 2005/0271259 A1
(43) Pub. Date: Dec. 8, 2005

(54) Method for detecting the relative movement of a finger in relation to a sensor surface

(75) Inventors: Henning Lorch, Munich (DE); Peter Morguet, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/136,611

(22) Filed: May 23, 2005

Related U.S. Application Data
(63) Continuation of application No. PCT/DE03/03629, filed on Oct. 31, 2003.

(30) Foreign Application Priority Data
Nov. 22, 2002 (DE) 102 54 614.2

(51) Int. Cl. G06K 9/00

(52) U.S. Cl. 382/124

(57) ABSTRACT

A method and system for detecting the relative movement of a finger in relation to a sensor surface. The method includes the steps of: (a) taking and temporarily storing a first partial image of the finger in a first subarea of the sensor surface, (b) tracking the movement of the finger using a movement of the first partial image of the finger by monitoring adjacent areas of the sensor surface for occurrence of partial images correlating with the temporarily stored first partial image, and (c) repeating step (b) until the tracked section of the finger has left a predetermined area of the sensor surface.

### CROSS-REFERENCE TO RELATED APPLICATION

This application is a continuation of International Patent Application Serial No. PCT/DE2003/003629, filed Oct. 31, 2003, which published in German on Jun. 10, 2004 as WO 2004/049254, and is incorporated herein by reference in its entirety.

### FIELD OF THE INVENTION

The invention relates to a method for detecting the relative movement of a finger in relation to a sensor surface.

### BACKGROUND OF THE INVENTION

The prior art has disclosed fingerprint sensors that are of approximately the size of the area of a finger whose surface structure is to be evaluated. The most common fingerprint sensors are those based on a capacitive measurement method. With such fingerprint sensors, a multiplicity of electrodes each having a stray capacitance relative to the surroundings are formed on a silicon surface. The capacitance of the capacitors formed therefore depends on the surroundings of the electrode. When a finger has been applied, it is possible to detect on the basis of the capacitance whether the electrode lies opposite a depression in the finger, or whether it is in contact with the skin via a passivation layer. A gray scale image of the fingerprint can be compiled by evaluating the capacitance values.

The disadvantage of such fingerprint sensors resides in the large area required and in the high manufacturing costs, since it is expensive to manufacture a silicon surface of the size required to sense a complete fingerprint.

Fingerprint sensors have become known, for example from EP 0 813 164 A1, which are strip-shaped and are as wide as a finger, while the dimension perpendicular thereto is substantially smaller. The manufacturing costs of such a sensor are substantially lower. Since the finger is moved over the sensor in order to obtain a complete image, the partial images taken during the movement must be combined again to form a total image. A problem in this is that the speed of the finger movement is not known in advance and, moreover, it is to be assumed that the finger is not being moved rectilinearly.

In the method disclosed in EP 0 813 164 A1, the partial images are taken such that mutually overlapping areas are produced, and that it is possible to detect with the aid of the overlaps how the partial images are to be combined. This method is very computational intensive and, moreover, storage intensive. The overlaps entail a redundancy of data that render it possible to combine the partial images. As a rule, the overlaps are much greater than would be necessary to calculate the arrangement of the partial images. The reason for this is that it is not known in advance how quickly the finger is being moved. If a finger is moved much more slowly than would be possible in theory, the partial images are taken nevertheless at the same rate as for a rapid finger movement. Consequently, very many redundant data are collected and stored.

Precisely in the case of miniaturized systems such as on chip cards, for example, it is of decisive importance that the computational outlay on the tasks to be accomplished is as low as possible, since the processors of chip cards are of comparatively low power, this being ascribable, inter alia, to the fact that precisely in the case of contactless chip cards there is not enough energy available on demand to enable a higher computing power in conjunction with a higher clock frequency. Moreover, raising the power also entails raising costs, for which reason powerful chip cards would be uneconomic in many instances.

Another possibility of compiling a complete image of a fingerprint with the aid of a strip sensor consists both in taking partial images and in adopting a movement function of the finger such that it is possible to calculate the correct positioning of partial images relative to one another with the aid of the movement function. In order to be able to produce a complete image later with the aid of the movement function even in the case of a rapid finger movement, partial images must be taken at a comparatively high clock-pulse rate, although this would not be necessary as such given a slow finger movement. Otherwise, gaps would be produced in the image of the fingerprint. Moreover, it is problematic that an accurate finger image can be produced only when the movement function of the finger is determined very precisely.

### SUMMARY OF THE INVENTION

It is therefore an object of the invention to specify a method for detecting the relative movement of a finger in relation to a sensor surface that is very accurate and, moreover, easy to implement, in particular does not place high demands on the available storage and on the available computational capacity. The aim is also to specify a suitable reading device for fingerprints.

The object is achieved by a method having the steps of:

a) taking and temporarily storing a first partial image of the finger in a first subarea of the sensor surface,

b) tracking the movement of the finger with the aid of the movement of the first partial image of the finger by monitoring adjacent areas of the sensor surfaces (1) for the occurrence of partial images correlating with the first partial image, and

c) repeating step b) until the tracked section of the finger has left a predetermined area of the sensor surface.

A reading device for fingerprints that achieves the object has a sensor surface for sensing the surface structure of a finger that is in contact with the sensor surface and is moving over the sensor surface, an imaging device for compiling an image from partial images taken in sections, and a sequence control system, connected to the imaging device, for controlling the sequence for reading the fingerprint, and which is defined by a movement detector connected to the sequence control system.

### BRIEF DESCRIPTION OF THE DRAWINGS

The invention is explained in more detail below with the aid of an exemplary embodiment. In the drawing:

FIG. 1 shows a schematic of a reading device for fingerprints;

FIG. 2 shows an expanded illustration of the reading device of FIG. 1;

FIG. 3 shows a diagram with the actual and detected finger movement without filtering; and

FIG. 4 shows a diagram as in FIG. 3 with filtering of the movement function.

### DETAILED DESCRIPTION OF PREFERRED EMBODIMENTS OF THE INVENTION

An advantage of the method according to the invention resides in that the movement of the finger or of the first partial image is tracked over a wider area of a sensor, and so temporary errors, for example quantization errors, can be compensated during a further movement of the finger. The movement parameters can be determined during the reading operation by means of fast logic circuits without the need to store voluminous image data temporarily and evaluate them subsequently. The volume of data that arises is therefore very low, an extremely high precision being achieved by tracking over a greater area of the sensor surface.

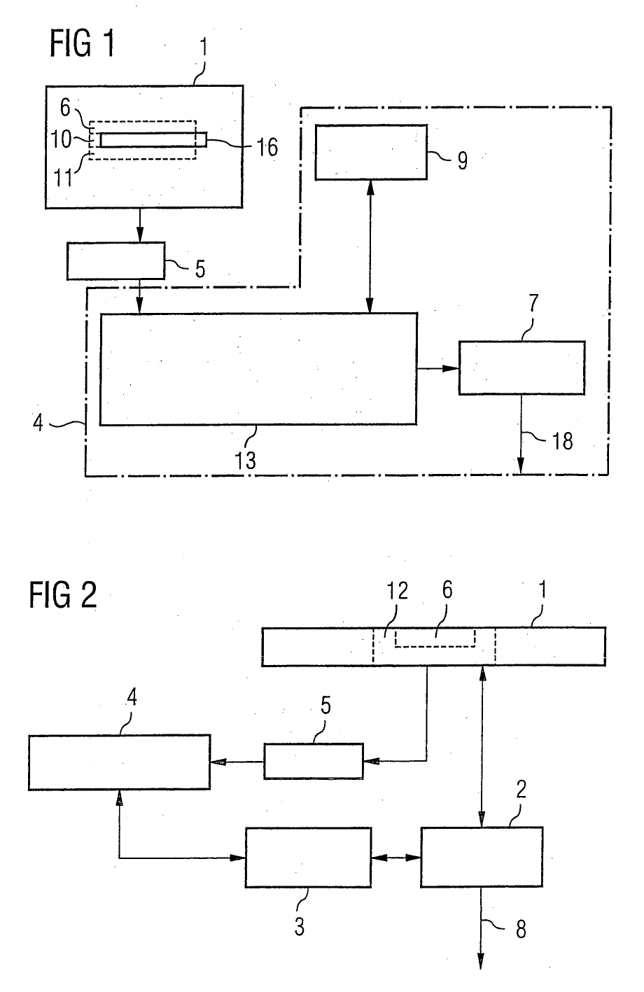

FIG. 1 shows a reading device for fingerprints having a sensor surface 1, an image processing device 5 that converts the capacitance values determined by the sensor surface 1 into a digital signal, and a movement detector 4 that uses the determined image data to determine the movement of a finger in relation to the sensor surface 1 and has a calculation unit 13, a partial image memory 9 and an optional output filter 7. The output filter 7 filters the movement function determined by the calculation unit 13 in order to be able to provide an error-corrected or smoothed movement function 18.

A relative movement of a finger in relation to the sensor surface 1 is detected by firstly taking a partial image in a first subarea 6 of the sensor surface 1. After the binarization by the image processing device 5, the movement detector 4 stores the partial image in the partial image memory 9. In order to explain the mode of operation, it is assumed that the finger is now moved further such that the original partial image of the subarea 6 now comes to lie in a displaced area 16.

In a first embodiment, a second subarea 10, which borders the first subarea 6 in the exemplary embodiment of FIG. 1, is now considered. The collected data change is successively monitored in this subarea. The collected data also change in the second subarea 10 owing to the described displacement of the finger.

The partial images taken successively in the subarea 10 are likewise binarized and compared by the calculation unit 13 with the stored first partial image in the partial image memory 9. The comparison is conducted in this case such that not only are identical images detected, but a correlation is detected between the first partial image and the successively taken second partial image.

Only one partial image need be temporarily stored in this way.

In a second embodiment, a number of second subareas that are successively monitored are established, the correlations of the second partial images with the first partial image being simultaneously evaluated. Whereas in the first embodiment a lateral displacement of the finger leads to a worsening of the correlation, in the second embodiment a lateral displacement of the finger occurs from the determination of the second partial image, which has the highest correlation with the first partial image. The second subareas are established, for example, such that they are respectively displaced by one pixel.

Depending on the application, the second subareas are established in a main direction or in a number of directions starting from the first subarea. A fingerprint sensor in which the finger is intended to be moved in one direction over the sensor surface would therefore, for example, take account of this main direction and of the adjacent directions in order to sense the movement of the finger in this main direction and slight lateral deviations therefrom. A sensor would take account all the directions when the aim is to use the sensor surface to control a cursor on a display screen such that it is necessary to detect a movement in each direction of a two-dimensional coordinate system. Such application is present in the case of a so-called touch pad or a touch screen. Novel small display units with pixel accuracy which can find a place, for example, in mobile telephones, can thereby be implemented.

After the detection of a correlating second partial image, the coordinates of the second subarea or of the second subareas are “displaced” into that area of the sensor surface 1 adjacent to the previous second subarea or to the second subarea with the highest correlation, that is to say is established there again. The movement detector 4 subsequently compares the partial images taken in the newly established second subarea 11 or the newly established second subareas with the first partial image stored in the partial image memory 9.

During calculation of the correlation, the movement detector 4 detects a lateral deviation of the partial images that have been taken from the first partial image. By using this information in conjunction with the information as to when there is a correlation at all, the calculation unit 13 of the movement detector 4 can determine an exact movement function of the finger that is being moved over the sensor surface 1.

The above-described method steps are continued until the respectively newly established second subarea is adjacent to the lower edge of the sensor surface 1.

In order thereafter to be able to detect the further movement of the finger, the first subarea 6 is read out again and stored in the partial image memory 9. The method described can subsequently be carried out repeatedly, this time with the aid of the newly read and stored data of the first subarea. Depending on the lateral offset, the first subarea can be established in a fashion displaced from the original first subarea in an optimized design. By tracking an image section 16 over a number of rows of the sensor surface 1, temporary deviations, for example owing to quantization noise, are automatically corrected. Since only two small subareas need be compared to one another in the present case, the hardware required is very simple and the calculation unit 13 can be implemented by fast and cost-effective logic circuits.

In order to reduce further the storage required, it can be provided that the subarea evaluated for the detection of movement is substantially narrower than the width of the sensor surface. The reliability and precision of the detection of the movement is increased in an advantageous refinement in that movements are detected simultaneously by using different subareas, and the results are combined with one another.

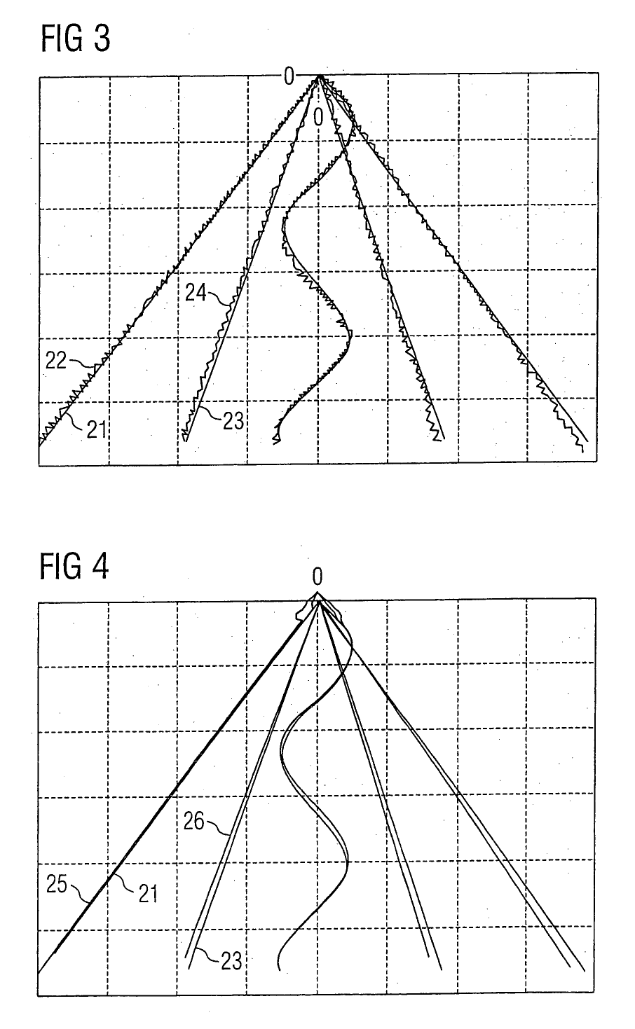

FIG. 3 shows on the basis of a diagram how, for example, the actual movement of the finger runs, and the movement function determined therefor. The straight lines 21 and 23 correspond here to an actual, exemplary movement of the finger, while the lines 22 and 24 show the movement function determined by the movement detector 4.

As described above, there is provided in the reading device of FIG. 1 a filter 7 that smooths the movement function determined by the movement detector 4 such that the output signal 8 experiences a further improvement. Such a filtered movement function is illustrated in FIG. 4. The straight lines 21 and 23 correspond once again, for example, to actual movements of the finger, whereas the lines 25 and 26 show the functions determined by the movement detector 4 and smoothed by the filter 7.

An expanded reading device for fingerprints is shown in FIG. 2. The sensor surface 1 is approximately the width of a finger. A part 12 of the sensor surface 1 is used for movement detection. The first subarea 6 is located horizontally in the middle of the sensor part 12 at the upper edge in FIG. 2. The first subarea 6 can have a height of a number of sensor rows. The second subarea, which is evaluated in order to determine the second partial image, is not established in this design directly adjacent to the first subarea, but is merely displaced by one pixel such that an overlap results. This is not illustrated in FIG. 2, in order to preserve the clarity of the figure.

An image processing device 5, a movement detector 4 and an imaging device 2 are provided in FIG. 1. The partial image memory 9 is not illustrated, for the sake of clarity. Also provided is a sequence control system 3. The sequence control system 3 controls the use of the reading device. When the movement detector 4 reports that the finger has moved by a further sensor row on the sensor surface 1, the sequence control system 3 interrupts the movement detection, triggers the imaging by the imaging device 2, one row being taken in the entire width of the sensor surface 1, and thereafter switches the movement detection on again. In this way, a fingerprint is produced row by row in the imaging device 2, a lateral offset being automatically compensated by an oblique movement of the finger. The image data are either successively output, or a complete image is compiled and the entire image is then output.

As set forth above, the application of the method according to the invention permits the quantization noise to be filtered out. It is thereby possible to reduce the number of gray scales of the image data and even to use binary images for movement recognition. The further logic circuits required for movement detection are therefore substantially simplified and can be constructed in a space-saving fashion. At the same time, the power requirement for the circuit is lowered. The images produced by the imaging device 2 can nevertheless be output in gray scales, since the data are collected for outputting or storage in a way independent of the collection of the data for image detection.

Moreover, the reading device described is also very compact, because movement is detected by using a part of the sensor surface that is required in any case for taking the image. By comparison with reading devices for fingerprints that make use of additional movement sensors, there is thus a further simplification leading to savings in space and costs.

1. A method for detecting the relative movement of a finger in relation to a sensor surface, comprising the steps of:
a) taking and temporarily storing a first partial image of the finger in a first subarea of the sensor surface;
b) tracking the movement of the finger using a movement of the first partial image of the finger by monitoring adjacent areas of the sensor surface for occurrence of partial images correlating with the temporarily stored first partial image; and
c) repeating step b) until the tracked section of the finger has left a predetermined area of the sensor surface.

2. The method as claimed in claim 1, wherein steps a) to c) are repeated as long as the finger is in contact with the sensor surface or until the movement of the finger satisfies a predefined condition.

3. The method as claimed in claim 1, wherein the step of tracking movement of the finger comprises the steps of:
a) establishing a second subarea, displaced relative to the first subarea, of the sensor surface;
b) successively taking a second partial image in the second subarea and determining a correlation between the second partial image and the temporarily stored first partial image; and
c) repeating step b) until the determined correlation satisfies predetermined conditions.

4. The method as claimed in claim 1, wherein the step of tracking movement of the finger comprises the steps of:
a) establishing a second subarea, displaced relative to the first subarea, of the sensor surface;
b) successively taking a second partial image in the second subarea and determining a correlation between the second partial image and the temporarily stored first partial image;
c) successively taking a first partial image in the first subarea and determining the correlation between the newly taken first partial image and the temporarily stored first partial image; and
d) repeating the partial steps of steps b) and c) until the correlation determined in step c) is greater than the correlation determined in step b).

5. The method as claimed in claim 1, wherein the step of tracking movement of the finger comprises the steps of:
a) establishing a plurality of second subareas, displaced relative to the first subarea, of the sensor surface;
b) successively taking second partial images in the second subareas and determining correlations between the second partial images and the temporarily stored first partial image;
c) determining the second partial image having the greatest correlation with the first partial image; and
d) repeating the partial step of step b) or the steps b) and c) until the determined correlation satisfies predetermined conditions.

6. The method as claimed in claim 1, wherein the step of tracking movement of the finger comprises the steps of:
a) establishing a plurality of second subareas, displaced relative to the first subarea, of the sensor surface;
b) successively taking second partial images in the second subareas and determining correlations between the second partial images and the temporarily stored first partial image;
c) determining the second partial image having the greatest correlation with the first partial image;
d) successively taking a first partial image in the first subarea and determining the correlation between the newly taken first partial image and the temporarily stored first partial image; and
e) repeating steps b) to d) until the correlation determined in step d) is greater than the correlation determined in step b).

7. The method as claimed in claim 1, further comprising the step of, after determining a correlating second partial image, determining the lateral offset from the first partial image.

8. The method as claimed in claim 1, further comprising the step of determining in one of the second subareas the temporal spacing up to the occurrence of a correlating second partial image.

9. The method as claimed in claim 1, further comprising the step of detecting movement simultaneously using different subareas.

10. A reading device for fingerprints, comprising:
a sensor surface for sensing a surface structure of a finger that is in contact with and moving over the sensor surface;
an imaging device for compiling an image from partial images taken in sections;
a sequence control system, connected to the imaging device, for controlling the sequence when reading a fingerprint; and
a movement detector connected to the sequence control system for implementing the method as claimed in claim 1.

11. The reading device as claimed in claim 10, wherein the sequence control system causes the imaging device to take an image section intended to be output after the detection of a defined further movement of the finger by the movement detector.

12. The reading device as claimed in claim 11, wherein the sequence control system causes an image row intended to be output and/or stored to be taken after the further movement of the finger by a sensor row.

13. The reading device as claimed in claim 11, wherein the sequence control system causes an image section intended to be output and/or stored to be taken when the movement detector has reached the edge of a predetermined sensor area when tracking the finger.

14. The reading device as claimed in claim 10, wherein the movement detector has a filter for error correction.

15. The reading device as claimed in claim 10, wherein the width of the sensor surface is greater than the dimensions in the direction of movement of the finger.

16. A system for detecting the relative movement of a finger in relation to a sensor surface, comprising:
means for taking and temporarily storing a first partial image of the finger in a first subarea of the sensor surface; and
means for tracking the movement of the finger using a movement of the first partial image of the finger by monitoring adjacent areas of the sensor surface for occurrence of partial images correlating with the temporarily stored first partial image, until the tracked section of the finger has left a predetermined area of the sensor surface.

17. The system as claimed in claim 16, wherein the means for tracking comprises:
means for establishing a second subarea, displaced relative to the first subarea, of the sensor surface;
means for successively taking a second partial image in the second subarea and determining a correlation between the second partial image and the temporarily stored first partial image, until the determined correlation satisfies predetermined conditions.

18. The system as claimed in claim 16, wherein the means for tracking comprises:
means for establishing a second subarea, displaced relative to the first subarea, of the sensor surface;
means for successively taking a second partial image in the second subarea and determining a correlation between the second partial image and the temporarily stored first partial image;
means for successively taking a first partial image in the first subarea and determining the correlation between the newly taken first partial image and the temporarily stored first partial image.

19. The system as claimed in claim 16, wherein the means for tracking comprises:
means for establishing a plurality of second subareas, displaced relative to the first subarea, of the sensor surface;
means for successively taking second partial images in the second subareas and determining correlations between the second partial images and the temporarily stored first partial image; and
means for determining the second partial image having the greatest correlation with the first partial image; and

20. The system as claimed in claim 16, wherein the means for tracking comprises:
means for establishing a plurality of second subareas, displaced relative to the first subarea, of the sensor surface;
means for successively taking second partial images in the second subareas and determining correlations between the second partial images and the temporarily stored first partial image;
means for determining the second partial image having the greatest correlation with the first partial image; and
means for successively taking a first partial image in the first subarea and determining the correlation between the newly taken first partial image and the temporarily stored first partial image.

21. The system as claimed in claim 16, further comprising a means for determining, after determining a correlating second partial image, the lateral offset from the first partial image.

22. The system as claimed in claim 16, further comprising a means for determining in one of the second subareas the temporal spacing up to the occurrence of a correlating second partial image.

23. The system as claimed in claim 16, further comprising a means for detecting movement simultaneously using different subareas.

24. A computer program having a program code for performing a method for detecting the relative movement of a finger in relation to a sensor surface, comprising the steps of:
a) taking and temporarily storing a first partial image of the finger in a first subarea of the sensor surface;
b) tracking the movement of the finger using a movement of the first partial image of the finger by monitoring adjacent areas of the sensor surface for occurrence of partial images correlating with the temporarily stored first partial image; and
c) repeating step b) until the tracked section of the finger has left a predetermined area of the sensor surface.
